(19) United States
(12) Patent Application Publication
(10) Pub. No.: US 2026/0340230 A1
(43) Pub. Date: Oct. 29, 2026

(54) A COMPUTER-IMPLEMENTED METHOD, A COMPUTER PROGRAM AND A COMPUTER FOR GENERATING A DIGITAL TWIN FOR A CHEMICAL PROCESS OR AN APPARATUS OR A SYSTEM OF A CHEMICAL PLANT

(71) Applicant: Evonik Operations GmbH, Essen (DE)

(72) Inventors: Philip GEBUS, Essen (DE); Peter KREIS, Dortmund (DE); Leif NETT, Iserlohn (DE); Markus PRISKE, Salzburg (AT)

(73) Assignee: Evonik Operations GmbH, Essen (DE)

(21) Appl. No.: 19/117,807

(22) PCT Filed: Oct. 6, 2023
(86) PCT No.: PCT/EP2023/077693

§ 371 Date: Apr. 2, 2025

(30) Foreign Application Priority Data
Oct. 6, 2022 (EP) 22200003.6

(51) Int. Cl. G06F 30/27

(52) U.S. Cl. CPC G06F 30/27

(57) ABSTRACT

The invention concerns a computer-implemented method for generating a digital twin (20) for a chemical process or an apparatus or a system of a chemical plant, in particular for substance synthesis and/or substance separation, the method comprising the steps of:
a) Inputting a plurality of boundary conditions (1) to a computational model (2), the computational model (2) comprising a system of equations, wherein each boundary condition (1) comprises a plurality of parameter values (4) respectively,
b) Inputting initial conditions for solving the system of equations,
c) Solving the system of equations using each of the boundary conditions (1) to provide a corresponding simulation result, respectively, in a simulation step, wherein a single one of the parameter values (4) of a respective boundary condition (1) is changed from one simulation step to the next simulation step, while the other parameter values (4) belonging to the respective boundary condition remain unchanged, and
d) Providing the digital twin (20) as a set of data points obtained from the simulation steps. The invention also concerns a computer program and a computer (55) for generating a digital twin for a chemical process or an apparatus or a system of a chemical plant, in particular for substance synthesis and/or substance separation.

The invention concerns a computer-implemented method, a computer program and a computer for generating a digital twin for a chemical process or an apparatus or a system of a chemical plant.

It is generally known that gas mixtures can be separated by means of gas separation membranes due to different permeabilities of the individual gases. In order to produce such gas separation membranes, polymers are processed into hollow fibers or flat membranes. The membranes are characterized by a very thin separation layer so that the permeance of the membrane is as high as possible.

In addition to new membrane materials, various ways of connecting membranes have been investigated in the prior art. A number of single or multi-stage membrane compounds for gas separation are known in the literature.

Exemplary literature sources include: Baker, IndEngChemRes, Natural Gas Processing with Membranes, 47 (2008); Bhide MemSci, Hybrid processes for the removal of acid gases from natural gas, 1998. The specified methods have the disadvantage that they in part include a plurality of recompression steps or that either only a high purity of the permeate gas or only a high purity of the retentate gas can be achieved.

WO 2012/00727; WO 2013/098024; WO 2014/075850; KR10-1327337; KR10-1327338; U.S. Pat. No. 6,565,626 B1; U.S. Pat. No. 6,168,649 B1; JP 2009-242773 A; WO 2014/183977; EP 0 799 634 each disclose membrane separation processes with
three membrane separation stages, wherein a retentate stream from stage 3 and a permeate stream from stages 2 are recycled to the crude gas stream. WO 2012/00727; WO 2013/098024 and WO 2014/075850 represent the most optimized
of all of these processes. In said patents an apparatus and a process are described which are optimized in view of product purity in combination with the lowest energy consumption. In other words, these processes provide two high pure product streams in an energy optimized way.

Lately, however, a new problem has arisen that is not adequately solved by the devices and processes of the prior art. The problem is that there is generally a need for optimization when dealing with different natural or artificial gas sources, such as a fermenter. For example variations or fluctuations of the respective raw gas composition or of impurities etc., causes optimization requirements. Also specific requirements of the location of the plant cause a need for optimization. For example, in the case of off-shore drilling rigs space and weight of the apparatus need to be minimized without negative impact on performance and/or capacity of the plant. Therefore, there is a multifaceted need for a solution to simulate devices and processes for gas separation more efficiently, e.g. for taking into account different requirements, different optimization goals, different materials and/or different architectures, properties or capacities of existing plants and facilities. No adequate solution to this problem has been found in the state of the art. Further, in order to make such processes commercially viable, these processes are typically carried on a large scale; for this reason it is often impractical to run test-processes to determine optimal conditions. Furthermore, physically testing a wide range of scenarios would be impractical, and would risk damaging the equipment.

This problem is solved by a computer-implemented method for generating a digital twin for a chemical process or an apparatus or a system of a chemical plant, a computer program, and a computer for generating a digital twin for a chemical process or an apparatus or a system of a chemical plant according to the independent claims. Advantageous embodiments of the computer-implemented method for generating a digital twin for a chemical process or an apparatus or a system of a chemical plant are given in the dependent claims. Embodiments of the present invention can be freely combined with each other if they are not mutually exclusive.

A first aspect of the invention relates to a computer-implemented method for generating a digital twin for a chemical process or an apparatus or a system of a chemical plant, in particular for substance synthesis and/or substance separation.

A digital twin may be a digital representation of a system or an apparatus. The digital twin may in some cases comprise one or more of the following: at least partially identical and/or scaled geometrical properties of the real system or apparatus, material properties, initial conditions, and boundary conditions at least partially identical to that of the real system or apparatus. The geometrical properties may include the geometrical dimensions, the geometrical dimensions may be also scaled or modified at least partially using methods which would be known to a person skilled in the art. The material properties may include density of the material, conductivity of the material, porosity of the material, and other material properties which may be known to a person skilled in the art. The digital twin may be generated by a simulation software, where physical transport equations or numerical models are solved for a predefined set of predefined boundary and operating conditions values of the corresponding real system or apparatus to provide resulting simulated parameter values. The resulting parameter values can be validated with the corresponding real parameter values obtained from experiments on the corresponding real system or apparatus for similar predefined set of predefined boundary and operating conditions. A digital twin may comprise all data values obtained as the results of multiple simulation runs, or a sub-set thereof, e.g. a sub-set of validated parameter values or a sub-set of parameter values fulfilling other criteria.

Boundary conditions define the inputs of the simulation model. Some boundary conditions, such as velocity and volumetric flow rate, determine how a fluid enters or leaves the model. Other constraints, such as heat flow, determine the energy exchange between the model and its environment. Boundary conditions connect the simulation model to its environment. Most boundary conditions can be defined as either steady-state or transient. Steady-state boundary conditions persist throughout the simulation. Transient boundary conditions change with time and are often used to simulate an event or cyclic phenomenon.

Boundary conditions can be adjusted when the geometry of the digital twin is at least partially changed or scaled so that the effects of the adjusted boundary conditions, along with the at least partially changed or scaled geometry of the digital twin, are the same as those of the real system or device. Such adaptations of the boundary conditions are known to the person skilled in the art.

Unlike boundary conditions, initial conditions are only enforced at the beginning of the analysis. The initial conditions define the initial values for each solution field. Therefore, they may play an important role in the stability and computation time of steady-state simulations. To ensure a good convergence rate for a steady-state simulation, it may be a good practice to initialize the domain close to the expected solution. For example, if we are studying the cooling effects of a heat exchanger, it makes a big difference for the time required till convergence is reached whether we initialize the surface of the heat exchanger at 350 K or 800 K. In the case of a transient analysis, the initial conditions may be critical to the setup. They define the state of the system when time is zero and play an important role in the simulation.

An embodiment of the computer-implemented method comprises a first step of inputting a plurality of boundary conditions to a computational model, the computational model comprising a system of equations, wherein each boundary condition comprises a plurality of parameter values respectively.

The system of equations can be a system of partial differential equations, such as transport equations, and/or algebraic equations, such as thermodynamic equation of state, related to a chemical process or an apparatus or a system of a chemical plant, in particular for substance synthesis and/or substance separation. The boundary conditions comprising a plurality of parameter values can be specified by a set of discrete time/property pairs, such as a table. Furthermore, the boundary conditions can be specified as a continuous set of time/property pairs, such as a curve or a mathematical function. The parameter values can include pressure, temperature, mass flow rate, mole flow rate, volume flow rate, composition of feed, purity of species in a particular stream, ratio of membrane capacity in one stage compared to another stage, ratio of retentate pressure to permeate pressure in a particular stage, quotient of pressure ratio over one stage over another stage, selectivity, permeability, permeance and/or area of the membrane, and/or any other characterizing property or parameter. This can enable consideration of process parameters that are particularly likely to be subject to change over the life of a chemical process facility, or which are to be adapted in the design of a chemical or other industrial plant, e.g., a gas separation facility, in such a way that they deliver good results with regard to an optimization target or deliver good results despite restrictive, difficult framework conditions, etc.

The inputting of a plurality of boundary conditions can be conducted by selecting a set of parameter values corresponding to the respective boundary conditions from a database, or another external source, such as a cloud service/system, or a plurality of external sources. Further, the plurality of boundary conditions can be inputted manually by means of a data input device. The plurality of boundary conditions can also be inputted by means of user define functions, which may be in the form of computer codes or computer programs. The plurality of boundary conditions can be selected and then provided to the computational model. Including the boundary conditions with the system of equations can be solved in a software, such as Aspen Custom Modeler (ACM), however, other software like Aspen Plus, Aspen Hysis, ProMax, MATLAB, MathCad can also be used.

According to some examples, the system of equations is solved by a software which may comprise a numerical solver, i.e., a solver for numerical equations. A numerical solver may use one or more numerical approximation for finding approximate solutions of problems. An incremental optimization and the corresponding simulation results obtained in a given simulation step may be maintained, e.g. stored in the main memory and/or a database, and may be re-used in the next simulation run. This may have the advantage of increasing the performance, as the simulations converge quicker to a (local or global) optimization optimum and the number of simulations, also referred herein as “simulation steps”, and the associated time and computational resources required for loading in put data and/or updating the solver may be reduced.

The software can comprise a numerical solver or a solver which can solve the system of equations in a coupled manner, that is solving the equations together, or in a segregated manner, that is solving the equations one after another.

A second step of embodiments of the computer-implemented method comprises inputting initial conditions for solving the system of equations.

A third step of embodiments of the computer-implemented method comprises solving the system of equations using each of the boundary conditions to provide a corresponding simulation result, respectively, in a simulation step. According to the invention, a system of equations for a steady-state process simulation is set up for a given chemical process, apparatus or system, as is known per se. Furthermore, a simulation space is defined which can contain a large number of predetermined boundary conditions. For each of these given boundary conditions a simulation result is to be determined. This is to be done with as short a computation time as possible.

A solution to the underlying problem is provided by the inventive computer-implemented method, according to which a single one of the parameter values of a respective boundary condition is changed from one simulation step to the next simulation step, while the other parameter values belonging to the respective boundary condition remain unchanged. This means that only one of the parameter values is changed from one simulation step to the next, while the other parameter values belonging to a boundary condition remain unchanged. For example, said only one parameter may not be changed arbitrarily in the data space, but a nearest data point or value of the parameter, particularly in the set of boundary conditions, is chosen. This proximity to the boundary condition would lead the simulation to converge faster. Hence, the speed of the simulation as whole will be improved.

In other words, if a simulation is used to solve an equation comprising three parameters, i.e., a first parameter X, a second parameter Y and a third parameter Z. A first parameter value set comprises of a first plurality of data points, e.g., X₁ to Xₙ data points, a second parameter value set comprises a second plurality of data points, e.g., Y₁ to Yₘ data points, and a third parameter value set comprises a third plurality of data points, e.g., Z₁ to Zₒ data points. Then according to the inventive computer-implemented method, the first parameter X may be changed from one simulation step to the next simulation step through its value set 1 to n, while the other parameter values belonging to the respective boundary condition remain unchanged at Y₁ and Z₁. That is, for the first 1 to n number of simulation steps, the values of the first parameter set are changed covering all the n number of data points. However, the values of the second parameter and the third parameter are kept unchanged, e.g., the second parameter can have unchanged value of a first data point of the corresponding m number of data points, corresponding to Y₁ to Yₘ data points, and the third parameter can have unchanged value of a first data point of the corresponding o number of data points, Z₁ to Zₒ data points.

After the first n number of simulation steps by varying the first parameter X, then for the second n number of simulation steps, the values of the first parameter X are changed covering the n number of data points for X. However, the values of the second parameter Y is changed from Y₁ to Y₂ and the third parameter Z is kept unchanged at Z₁. For example, if n=4, i.e., the first parameters are X₁, X₂, X₃ and X₄, m=3, i.e., the second parameters are Y₁, Y₂ and Y₃ and o=2, i,e., the third parameters are Z₁ and Z₂.

Then in this case, for the first set of n=4 number of simulation steps, the following points are simulated: (X₁, Y₁, Z₁), (X₂, Y₁, Z₁), (X₃, Y₁, Z₁) and (X₄, Y₁, Z₁).

Then for the second set of n=4 number of simulations, the following points are simulated: (X₄, Y₂, Z₁), (X₃, Y₂, Z₁), (X₂, Y₂, Z₁) and (X₁, Y₂, Z₁).

Then for the third set of n=4 number of simulations, the following points are simulated: (X₁, Y₃, Z₁), (X₂, Y₃, Z₁), (X₃, Y₃, Z₁) and (X₄, Y₃, Z₁).

Then for the fourth set of n=4 number of simulations, the following points are simulated: (X₄, Y₃, Z₂), (X₃, Y₃, Z₂), (X₂, Y₃, Z₂) and (X₁, Y₃, Z₂).

Then for the fifth set of n=4 number of simulations, the following points are simulated: (X, Y₂, Z₂), (X₂, Y₂, Z₂), (X₃, Y₂, Z₂) and (X₄, Y₂, Z₂).

Then for the sixth set of n=4 number of simulations, the following points are simulated: (X₄, Y₁, Z₂), (X₃, Y₁, Z₂), (X₂, Y₁, Z₂) and (X₁, Y₁, Z₂).

Thus, this process is repeated until all possible combinations of the three parameters have been simulated.

Hence, according to embodiments, the simulation steps are preferably performed such that no parameter value “jumps” (is increased or decreased) from one step to another by more than one predefined increment, e.g. the integer “1” or another value, depending on the parameter. This means that there is preferably no “jump” form the lowest to the highest possible value in a predefined parameter value set or range. In the above example, there is no “jump” of the parameter X from 1 to 4 or from 4 to 1. The increment may also be referred to as “step length”.

The parameter values used for a simulation are increased or decreased in by predefined minimal increments as if they were selected by a movable slider.

Furthermore, the choice of the parameter as the parameter whose value would be changed while keeping the others constant can be dependent upon the time required for the whole simulation process to complete, i.e., the choice may be made as to achieve the simulation process to be completed in the shortest possible interval of time.

Therefore, due to this measure, the solver can calculate a new simulation result correspondingly fast, because it converges quickly.

The simulations of the inventive computer-implemented methods can be computed in parallel and/or sequentially. In the case of a parallel computation the simulation space for a respective set of boundary conditions is divided into several sub-spaces which will be simulated in parallel. Respective simulation result for each sub-space of the corresponding boundary conditions of the plurality of boundary conditions are determined, all at once or with a time offset depending on the embodiment. However, in the case of a series computation, one simulation result for one of the boundary conditions is determined at a time, that is each of the corresponding simulation result for each of the corresponding boundary conditions of the plurality of boundary conditions is determined one after the other in a sequential manner.

A fourth step of embodiments of the computer-implemented method comprises providing the digital twin as a set of data points obtained from the simulation steps. The digital twin can also be a parametric model or a numerical expression. The parametric model can be in form of a polynomial function, which can be obtained by an interpolation method or a curve fitting method associating the simulation result as a function of corresponding boundary conditions from the plurality of boundary conditions. The parametric model can be in the form of a gaussian function as well. This is of advantage, because such a parametric model is computationally inexpensive and fast as compared to a computation of a simulation result for a set of boundary conditions using the software.

The inventive method enables an efficient and a fast computation of the simulation results for a large set of boundary conditions for a chemical process or an apparatus or a system of a chemical plant, in particular for substance synthesis and/or substance separation. In addition, the use of changing a single one of the parameter values of a respective boundary condition from one simulation step to the next simulation step, preferably to the nearest data point or value of the parameter, while the other parameter values belonging to the respective boundary condition remain unchanged, allows for a set-up that can be run in a short amount of time on standard computing machines. As such, the computer-implemented method steps may be executed on at least one processor of a computer. Further, due to the complexity and sheer amount of data that has to be handled and computed by the processor, it may be of advantage to use an array of parallel processors to execute the computations necessary to perform the computer-implemented method steps.

It is to be understood, that additional intermediate steps, which could be as such known to a person skilled in the art could be performed between any consecutive steps of the inventive computer-implemented method.

According to some embodiments of the invention, the single one of the parameter values of the respective boundary condition can be varied in a simulation within its whole value set of data points from a starting data point to the end data point, wherein in the subsequent series of simulation, the single one of the parameter values of the respective boundary condition is varied backwards, that is from the end data point to the starting data point. This “back and forth” mechanism where in one series of simulation, that is in the fourth step, the single one of the parameter values of the respective boundary condition can be varied in a simulation within its whole value set of data points from a starting data point to the end data point, and in the subsequent series, that is in the back step, the single one of the parameter values of the respective boundary condition can be varied backwards, that is from the end data point to the starting data point. This “back and forth” mechanism can be continued for further subsequent following series of the simulation.

It is preferred to change the parameter to be varied in a simulation within its whole value set of data points from the starting forward to the end parameter and in the subsequent series of calculations backwards from the end to the starting parameter and so on. For example, in reference to the example mentioned above, where if a simulation is used to solve an equation comprising three parameters, i.e., a first parameter X, a second parameter Y and a third parameter Z. A first parameter value set comprises of a first plurality of data points, e.g., X₁ to Xₙ data points, a second parameter value set comprises a second plurality of data points, e.g., Y₁ to Yₘ data points, and a third parameter value set comprises a third plurality of data points, e.g., Z₁ to Zₒ data points. The parameter X can be varied in a first simulation from X₁ to Xₙ, in the second simulation from Xₙ to X₁, in the third simulation from X₁ to Xₙ and so on. It has been found out that said “forth and back” mechanism can significantly save calculation time compared to methods which always start at the starting parameter or which randomly select the parameters for each series of calculations. If starting from the simulation result for XₙY₁Z₁ the solutions for XₙY₂Z₁ can be much closer and can be found much faster than the solution for X₁Y₂Z₁. Details of the method explained before will be provided further below when discussing FIG. 2.

In a preferred embodiment the “back and forth” mechanism can be combined with a particular schema which determines a preferable, typically parameter-specific increment size (“step length”) and/or a further schema which determines the order according to which the multiple parameters will be selected for changing the respective parameter value “back and forth” during the simulations such that the overall simulation time is further reduced. This combination of mechanisms and calculation rules can result in a reduction of calculation time by up to 99% compared to conventional methods and thus, can provide the basis that much larger data spaces with much more boundary conditions can be simulated in an economically acceptable time. For example, a simulation may not converge at all if the value of the pressure is changed from the upper limit to the lower limit, e.g. in complex processes such as the three-stage biogas process. Then the next point can be “approached” by homotopy. This can then take 30-60 seconds, whereas the method may require only 0.5-1.5 seconds. This could lead to a reduction of the calculation or simulation time by up to 99%.

According to some embodiments of the invention, the simulation result from one simulation step can be used as the initial conditions for the next simulation step. In other words, a solution found by the solver is used by the solver in a subsequent simulation step for changed boundary conditions, e.g. as initial conditions or initial values, in order to be able to find a solution for the changed boundary conditions more faster. This is also known as a gradient-based method.

This is of advantage because, as the initial conditions, which have been obtained from the simulation result of the previous simulation step, for the current simulation step would be then close to the final simulation result of the current simulation step, this would ensure that the solution converges in a much shorter time. In the case where the solver cannot find a solution for a boundary condition, a homotopy can be used. Two continuous functions from one topological space to another are called homotopic if one can be “continuously deformed” into the other, such a deformation being called a homotopy between the two functions.

Homotopy may enable one to move from one steady state solution to another steady state solution in small increments. In some circumstances, the simulation may not converge for the target steady-state solution from the current steady-state solution. Homotopy may allow one to approach the target steady-state solution in stages, thereby improving the chances that the target steady-state solution is reached.

Homotopy may provide a way of moving from one converged solution to another solution with different values for one or more of the homotopy variables. It is a useful technique where it is difficult to obtain convergence for a particular specification, but where you already have a converged solution for a different specification. Homotopy may work by moving along a path to the new solution, and solving a number of interim points along the way. For example, Let HOM1 be the vector of values for the homotopy variables at the point that one has already solved, and HOM2 is the vector of values for the point to which one wants to move. In a homotopy simulation, the simulation software attempts to solve a number of points at values for the homotopy variables of:

Homotopy=HOM1+theta×(HOM2−HOM1)

Where, Theta is a Homotopy parameter. This is a number that is moved from 0 to 1 at the successive solutions. When theta is 1, this corresponds to the specification HOM2. One can control the way theta changes between successive solutions

In a case where a homotopy is used, a saved snapshot, i.e., a solution of a point, is loaded in and then the non-converged point is approached again by homotopy. Here, preferably, only one snapshot is loaded before starting the simulation, it must not matter which point is not converged. Furthermore the saving of the snapshots can be switched off for each single simulation, so that no additional time is lost for saving the snapshots or if the simulation software crashes because now 10000 or more snapshots could have been saved. The value of the changed parameter value of the current boundary condition is sub-divided into a plurality of values of the corresponding parameter value between the parameter value of the previous simulation step and the final parameter value of the current simulation step. In this case, several simulation steps are incorporated therebetween, wherein the simulation result of each of the simulation step is used as the initial condition for the subsequent simulation step. This procedure is repeated till the final simulation result using the final changed parameter value of the boundary condition is obtained.

According to some embodiments of the invention, the plurality of boundary conditions can be obtained from a simulation space, wherein the boundary condition for a first simulation step is chosen from a central region of the simulation space. In other words, the starting boundary condition is not chosen at the edge of the simulation space, but from the central region of the simulation space, because in the boundary regions of the simulation space there is a risk that the solver will not find a solution there, since generally the boundary regions of the simulation space comprise extreme values of a range of parameter values of the boundary conditions for which the simulation results need to be obtained.

A boundary region of the simulation space can comprise a maximum value und the other boundary region of the simulation space can comprise a minimum value of the corresponding parameter value. For example, if the simulation result is to obtain a reaction rate of a reaction mechanism, and the one parameter value of the boundary conditions that is changed corresponds to a temperature of the reactant mixture. At one boundary region, the parameter value would comprise a maximum possible value of the temperature of the reaction mixture, which would result in a very high reaction rate, as the reaction rate is an exponential function of temperature. Similarly, at the other boundary region, the parameter value would comprise a minimum possible of the temperature of the reaction mixture, for which the reaction rate would be of a very low value or even negative values which would be unrealistic. Simulations at such boundary conditions would require a long time to converge or do not converge or diverge, thereby leading to unrealistic values. This leads to a disproportionate loss of time that occurs when trying to find a solution numerically in physically or chemically boundary regions. Hence, bypassing such boundary regions can lead to avoid the use of homotopy or reduce the use of homotopy.

Alternatively, the boundary condition for a first simulation step can be chosen from any random point from the simulation space or also partly from a point close to an edge of the simulation space.

According to some embodiments of the invention, a path of choosing the boundary condition for the next simulation step can be adjusted dynamically through the simulation space based on the time required for obtaining the simulation result in the previous simulation step. In other words, it is conceivable to dynamically adjust the path through the simulation space during the execution of the simulations, e.g. if the time required by the solver for a simulation result becomes longer and longer. Physically boundary or infeasible regions could be “bypassed” in this way. For example, the plurality of boundary conditions can also be obtained from a simulation space, wherein the boundary condition for a first simulation step is chosen from a region lying in between a boundary region and the central region of the simulation space. Here, the path of selection of the boundary conditions for the next simulation step can be chosen based on whether the time required by the solver for a simulation result becomes longer than the previous simulation step, if the time required is longer, than the particular boundary condition could be bypassed and path of selection of the boundary condition within the simulation space can be adjusted accordingly, for example, the path can be in the form of a meander. Here, the boundary conditions requiring large time for the simulation are avoided, thereby the use of homotopy can be avoided or reduced.

According to some embodiments of the invention, the system of equations can be a steady-state system of equations of a quasi-steady state process. This is of advantage, because it leads to higher speed and analytical ease the simulation. However, the solver can also be capable of performing unsteady or transient simulations as well.

According to some embodiments of the invention, the inputting of the plurality of boundary conditions and the initial conditions of a simulation step can be realized by means of an interface to an external source. For access to an external source or resource or a plurality of external sources or resources, the external source can be chosen, such that it is compatible with software used to solve the system of equations of the simulations. For compatibility with the external source the computer-implemented method can comprise receiving data from and/or transmitting data to an external source or resource or system. For versatility the computer-implemented method may further comprise accessing external software and providing data to and/or receiving data from the external software. For compatibility an interface suitable for receiving prescription of an action from a further simulator can also be employed.

According to some embodiments of the invention, the digital twin is the set of data points comprising a plurality of simulation results in correspondence to the respective boundary conditions. This is of advantage because, this would enable a user to select or filter out a specific group of points from the digital twin as per the requirements, so as to obtain the respective simulation results in correspondence to the respective boundary conditions in a fast and efficient manner. It is further thinkable that a parametric model or a numerical expression can be obtained from the set of data points of the digital twin. As such a parametric model or numerical expression can be easily incorporated to obtain real time like applications or in other computer programs or computer software.

According to some embodiments of the invention, the chemical process can correspond to that of a gas separation membrane or a gas separation arrangement with a plurality of gas separation membranes, or the apparatus or the system of the chemical plant can be a gas separation membrane or a gas separation arrangement with a plurality of gas separation membranes. This is of advantage, because this would enable testing and developing a gas separation membrane or a gas separation arrangement with a plurality of gas separation membranes, or the apparatus or the system of the chemical plant can be a gas separation membrane or a gas separation arrangement with a plurality of gas separation membranes that are capable of operating in wide range of operating conditions in an efficient and economical manner.

According to some embodiments of the invention, a plurality of systems of equations, each using corresponding boundary conditions to provide a corresponding simulation result, can be solved in parallel in a simulation step. For this purpose, the simulation space can be divided into several parallel “slices”, i.e. subspaces of the simulation space that are parallel to each other. A path for the parallel simulations can run through each of the subspaces. It is further possible, that the simulation space is subdivided into blocks of subspaces which are not in the form of parallel slices or can be a combination of blocks of subspaces and parallel slices, wherein each of the subspaces of the simulation space are solved in parallel to each other in a simulation step. Such parallel simulations can be run on a single computer or cluster or cloud computer system.

According to some embodiments of the invention, a time offset can be used for starting a solving of each of the system of equations in parallel with respect to solving one of the system of equations, wherein the time offset is a predefined fraction of the average time of a simulation step. It is advantageous to start the parallelized simulations with a time offset because this would smoothen the total required processor power over time.

The predefined fraction of the average time of a simulation step can lie between 5% and 10% of the average time of a simulation step. For example, a simulation step can take 0.5 to 1.5 seconds, then the offset can be selected or set to 45 seconds. In general, starting the simulation takes much longer. A converged solution from a previous simulation can be saved as a “snapshot” file, and this “snapshot” can then be loaded into the appropriate software, such as the ACM software. This snapshot is then brought to convergence for the new set of boundary conditions. If convergence is not achieved, homotopy can be used, and a simulation step can take about 30 to 60 seconds.

According to some embodiments of the invention, the simulation results can be stored in one data file or in a plurality of data files. This enables an efficient storage and a convenient usage of a large data of simulation results as per requirement. For clarity and convenience, the computer-implemented method may further comprise providing a sequence of simulation results and allowing each result within the sequence to be reviewed in detail. For convenience the simulation results may be displayed in the form of a chart, a plot, a list, a table and/or a graph. The progress of the simulation can be displayed in form of a cumulative value of the ongoing simulation.

According to some embodiments, the number of simulation steps performed is at least 100,000, in particular at least 250,000, in particular at least 500,000 and in particular at least 1,000,000. The number of data points each comprising a respective one of the simulation steps may also be at least 100,000, in particular at least 250,000, in particular at least 500,000 and in particular at least 1,000,000.

According to some embodiments, the number of boundary condition parameters whose values are varied in the simulation steps is at least 3, in particular at least 5, in particular at least 7, and in particular at least 9 an.

According to some embodiments, the average number of predefined values assigned to one of the boundary condition parameters which are changed during the simulation steps is at least 2, in particular at least 4, in particular at least 8, in particular at least 64 e.g. at least in particular at least 256.

The specific way in which the simulations are carried out by increasing only one parameter at a time, and preferably only by a single increment, and preferably according to a specific parameter prioritization and a specific method of selecting suitable parameter-specific step widths, can therefore make it possible to calculate a huge number of simulation results and thus to cover a huge combinatorial space which could not previously be covered either by empirical, observational approaches or by bruit-force simulation approaches. According to some embodiments of the invention, the simulation results (e.g. the plots depicted in FIG. 10) can be displayed via an augmented reality display system, e.g. via augmented reality glasses (AR-glasses). The AR-glasses may be controlled by an AR-software configured to create and display one or more digital twins (digital representations) of a chemical process or an apparatus or a system of a chemical plant. This may enable a user wearing AR-glasses to immediately recognize any problems which may arise under some process condition and to immediately take action to prevent or remedy critical situations. For example, according to one embodiment, the controller is configured to compute a digital twin for the user wearing the AR glasses and enable the user to move, by moving his head and/or body in the real world, his or her virtual twin relative to the digital twins representing e.g. parts of the chemical reaction or parts of a chemical plant.

According to some embodiments, the computer-implemented method further comprises displaying the digital twin. For example, the displaying may comprise displaying the digital twin via an augmented reality display system, e.g., via AR glasses.

As embodiments provide for a particularly fast computation of the data points/the digital twin, also a particularly fast method of displaying the digital twin is provided: the graphical representation of the digital twin, e.g. a multidimensional plot of data points or a more sophisticated graphical representation of individual hardware components of a plant can quickly be read into the frame buffer without having to solve numerical equations for determining a predicted state of a chemical process or plant.

According to some embodiments, the displaying of the digital twin comprises loading a graphical representation of the digital twin or a part thereof into a frame buffer of a display system, and displaying the data content of the frame buffer on the display system. The framebuffer is a portion of random-access memory containing a bitmap that drives a video display. It is a memory buffer containing data representing all the pixels in a complete video frame.

In some embodiments, the method comprises subsequentially displaying at least two different states of a chemical process, plant or machine on a display system, wherein the displaying comprises selecting a first subset of the data points obtained in the totality of simulations, generating a first graphical representation of the process, plant or machine using the selected first subset, loading the first graphical representation into the framebuffer, displaying the content of the frame buffer comprising the first graphical representation on the display system, selecting a second subset of the data points, generating a second graphical representation of the process, plant or machine using the selected second subset, loading the second graphical representation into the framebuffer such that it replaces the first graphical representation, and displaying the content of the frame buffer comprising the second graphical representation on the display system.

For example, a rules-engine can be used for identifying sub-sets of data points which correspond to two or more different states of the chemical process, machine or plant of interest. In some cases, the sub-set may comprise a single data value. For example, if the user is interested in the state (defined by a plurality of parameter values) of a gas separation plant where a certain degree of purity is required given a certain pressure, he or she may use the rules engine for obtaining a first data point comprising the required degree of purity and being annotated with temperature T1, and for obtaining a second data point comprising the required degree of purity and being annotated with a different temperature T2. The different temperatures represent different states of the process, machine or plant. The user may navigate in real time between graphical representations of different states of the chemical process, machine or plant, which is particularly useful in the context of industrial control processes, an in particular if the control is executed via an augmented reality display system. Typically, the state-selection rules used for traversing the set of data points obtained by the simulations will be more complex and may comprise filter criteria concerning multiple different parameters such as permeance of a gas, e.g., O2 or N2, purity of a gas, surface area of a membrane, temperature, pressure, feed gas flux, permeate gas flux, retentate gas flux, etc.

According to some embodiments of the invention, the digital twin can be used to train an artificial intelligence model or a machine learning based model. The artificial intelligence model or AI twin or the machine learning based model can be of advantage for the visualization of big data of the simulation results together with corresponding boundary conditions, a fast optimization can be enabled and also a real time optimization and advanced process control can be enabled. Furthermore, the artificial intelligence model can be used in grey box models and surrogate models such as a neural network model, or a radial basis function model, or a support vector machine model, or a Gaussian process regression model. The machine learning based model may be a k-nearest neighbors algorithm based model which is a non-parametric supervised learning method, wherein a supervised learning is a machine learning task of learning a function that maps an input to an output based on example input-output pairs. The model can be used for performance prediction and also for other unit operations, e.g. distillation, absorption and other operations in the field of chemical processes which would be known to a person skilled in the art.

According to some embodiments of the invention, the digital twin may be the set of data points comprising a plurality of simulation results in correspondence to the respective boundary conditions and is graphically represented, such that specific set of data points out of the set of data points of the digital twin can be selected or filtered, for example by the user as per requirements. This is of advantage because, this can display good and bad solutions directly and make them comparable and, understandable, even allow the user to move around in or through the data space, for example by means of a digital slider of a 2D-plot or a 3D-Plot.

A second aspect of the invention is a computer program comprising instructions which, when the program is executed by a computer, cause the computer to carry out the steps of the inventive computer-implemented method for generating a digital twin for a chemical process or an apparatus or a system of a chemical plant, in particular for substance synthesis and/or substance separation. For example, the substance separation may be performed by permeation, adsorption, absorption, distillation, filtering or other technical means. The separation may be performed for fractionating or purifying substance mixtures such as gas mixtures or other types of mixtures. The computer program can also comprise a computer program product comprising instructions which, when the program is executed by a computer, cause the computer to carry out the steps of the inventive computer-implemented method.

Particularly, the set of parameters may be provided to the computer program from the non-transitory storage medium of a computer, as elaborated in the context of the first aspect of the invention.

A third aspect of the invention is a computer for generating a digital twin for a chemical process or an apparatus or a system of a chemical plant, in particular for substance synthesis and/or substance separation configured to use the steps of the inventive computer-implemented method. Further, the computer executing the computer program may be connected to a display that is configured to display any output of the of the computer program.

A further aspect of the invention is a display system comprising an electronic display and a computer configured for generating the digital twin. For example, the computer can be a distributed or monolithic computer system. The electronic display can be an LCD screen, an OLED screen or any other type of electronic display. The computer is further configured for generating a 2D or 3D computer graphics visualizing the data in the digital twin (e.g. a plot, a chart, or an approximately realistic representation of the chemical process or a plant or machine where the chemical process is performed). The computer is configured for displaying the 2D or 3D computer graphics on the electronic display.

A further aspect of the invention is a data structure configured for use for visualizing a digital twin of a chemical process or an apparatus or a system of a chemical plant, the data structure comprising a plurality of data points obtained by a method according to any one of the embodiments and examples described herein. The data structure is configured to cause, upon being processed by a display system, the display system to generate a 2D or 3D computer graphics visualizing the data in the digital twin; and displaying the 2D or 3D computer graphics on an electronic display of the display system.

This may have the advantage of providing a particularly fast and lightweight display system which is able to visualize a chemical process or a plant or machine conducting a chemical process very quickly. The graphical representation can be derived directly from a set of data points without having to solve complex simulations, and the computing of the set of data point is also executed very fast. In fact, the display system can be a particularly fast and high-resolution display system, because the density of the data points in the multidimensional parameter space reflects the resolution of the 2D or 3D model of the entity represented by the digital twin. Given a certain amount of computation time and computational resources, the way of computing the data points by changing only one parameter value from one simulation to the next can provide a better resolution, as more simulations can be conducted and converge per amount of time/CPU power available.

The term ‘computerized device’, ‘computerized system’ or a similar term denotes an apparatus comprising one or more processors operable or operating according to one or more programs.

The term ‘computer’ or system thereof, may be used herein as ordinary context of the art, such as a general-purpose processor or a micro-processor, RISC processor, or DSP, possibly comprising additional elements such as memory or communication ports. Optionally or additionally, the terms ‘computer’ or derivatives thereof denote an apparatus that is capable of carrying out a provided or an incorporated program and/or is capable of controlling and/or accessing data storage apparatus and/or other apparatus such as input and output ports. The term ‘computer’ denotes also a plurality of processors or computers connected, and/or linked and/or otherwise communicating, possibly sharing one or more other resources such as a memory inform of a non-transitory storage medium.

As used herein, the terms ‘server’ or ‘client’ or ‘backend’ denotes a computer or a computerized device providing data and/or operational service or services to one or more other computerized devices or computers.

The terms ‘software’, ‘computer program’, ‘software procedure’ or ‘procedure’ or ‘software code’ or ‘code’ or ‘application’ or ‘app’ may be used interchangeably according to the context thereof, and denote a product or a method comprising one or more instructions or directives or circuitry for performing a sequence of operations that generally represent an algorithm and/or other process or method. The program may be stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

As used herein, without limiting, a process represents a collection of operations for achieving a certain objective or an outcome.

Similarly, a model may represent a collection of operations for achieving a certain objective or an outcome

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device, such as a non-transitory storage medium, storing and/or comprising a computer program and/or data particularly constitutes an article of manufacture. Unless otherwise specified, the program and/or data are stored in or on a non-transitory medium.

In the context of embodiments of the present disclosure, by way of example and without limiting, terms such as ‘operating’ or ‘executing’ imply also capabilities, such as ‘operable’ or ‘executable’, respectively.

### BRIEF DESCRIPTION OF THE DRAWINGS

In the following embodiments of the invention are explained in greater detail, by way of example only, making reference to the drawings in which:

FIG. 1 a block diagram of an embodiment of the inventive system for generating a digital twin for a chemical process or an apparatus or a system of a chemical plant;

FIG. 2 a parameter table comprising plurality of boundary conditions comprising a set of parameter values;

FIG. 3 a digital twin as a set of points obtained from the simulation steps;

FIG. 4 a first path of choosing the boundary conditions from a simulation space;

FIG. 5 a second path of choosing the boundary conditions from a simulation space;

FIG. 6 a flow chart of an embodiment of the computer-implemented method, wherein the digital twin is provided as a set of data points obtained from the simulation steps;

FIG. 7 a comparison of the simulation results obtained by the ACM solver and the artificial neural network model; and

FIG. 8 a flow chart embodiment of the computer-implemented method, wherein in the case of parallel simulations, wherein a time offset is used for starting a solving of each of the system of equations in parallel with respect to solving one of the system of equations;

FIG. 9 a schematic diagram of a computer for generating a digital twin for a chemical process or an apparatus or a system of a chemical plant, in particular for substance synthesis and/or substance separation configured to use the computer-implemented method;

FIG. 10 a filtering of data obtained from the digital twin;

FIG. 11A, B an illustration of the impact of step selection on simulation performance;

FIG. 12 a set of tables for illustrating the identification of a suitable step width;

FIG. 13 a set of tables for illustrating the identification of a suitable parameter order;

FIG. 14 a plot illustrating the simulation times observed for three different parameters assuming different numbers of allowed values per parameter; and

FIG. 15 a flow chart of an embodiment of the inventive computer-implemented method for generating a digital twin for a chemical process or an apparatus or a system of a chemical plant.

FIG. 15 shows a flow chart of an embodiment of the inventive computer implemented method for generating a digital twin for a chemical process or an apparatus or a system of a chemical plant, while FIG. 1 shows a corresponding system configured to perform this method. FIGS. 1 and 15 will hence be described together. The computer-implemented method comprises a first step 150 of inputting a plurality of boundary conditions 1 to a computational model 2. The computational model 2 comprising a system of equations is solved in a process simulation software 8, such as Aspen Custom Modeler, ACM. Each boundary condition 1 comprises a plurality of parameter values 4. The boundary conditions 1 comprising a plurality of parameter values 4 can be specified by a set of discreet property pairs in a steady state. The parameter values 4 of the respective boundary conditions 1 can be stored in a tabulated database 6, for example Microsoft Excel. This tabulated database 6 can be inputted into the computational model 2. The parameter values 4 of the respective boundary conditions 1 read from the tabulated database 6, can be stored in form of a parameter table data 5, as shown in FIG. 2. The parameter values 4 can include pressure, temperature, mass flow rate, mole flow rate, volume flow rate, composition of feed, and/or any other characterizing property or parameter, each shown in a respective column 7 within the parameter table data 5. The inputting of a plurality of boundary conditions 1 can be conducted by selecting a set of parameter values 4 corresponding to the respective boundary conditions 1 from the tabulated database 6, such as the Microsoft Excel in this case, or another external source, such as a cloud service/system, or a plurality of external sources. It should be noted that in Microsoft Excel the variables, e.g., temperature or pressure, can be defined by entering their maximum and minimum values as the outer limits of the data points for which the simulations are to be performed and the step size to calculate the other data points in between. Alternatively, a sequence of data points or a grid of data points can be entered, or a tabular database can be entered, which can be created in software such as Konstanz Information Miner, KNIME, for example.

A second step 152 of the inventive computer-implemented method comprises inputting initial conditions for solving the system of equations to the computational model 2 of the process simulation software 8. The inputting of the boundary conditions 1 from the tabulated database 6 to the computational model 2 is performed automatically via a data analysis software, such as KNIME. The double arrow indicates that the simulation result from one simulation step from the computational model 2 is used as the initial conditions 3 for the next simulation step.

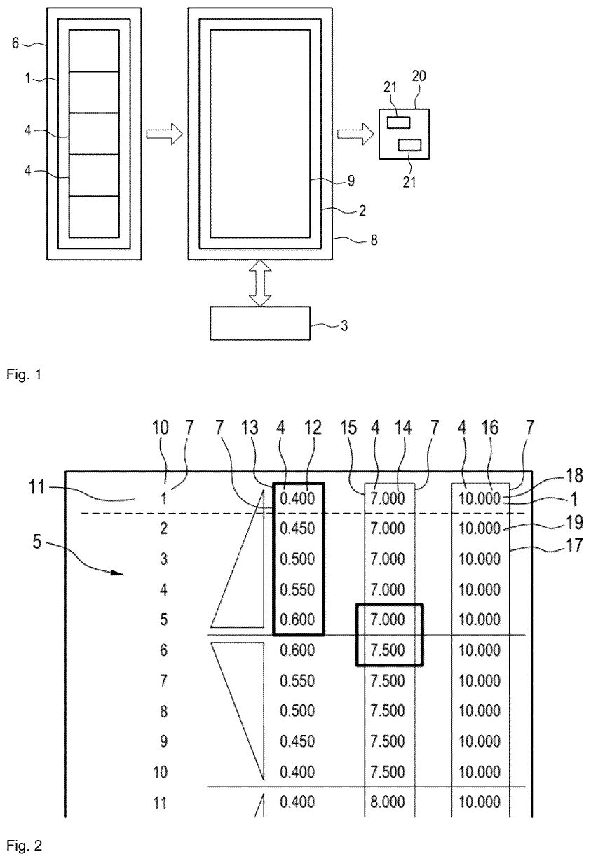

FIG. 1 shows that the graphic user interface 9 of the process simulation software 8. Including the boundary conditions 1 with the system of equations can be solved in the process simulation software 8. Further, in order to speed up, the GUI may not be opened by ACM and is rather allowed automatically to on.

A third step 154 of the computer-implemented method comprises solving the system of equations using each of the boundary conditions 1 to provide a corresponding simulation result, respectively, in a simulation step.

A fourth step156 of the computer-implemented method comprises providing the digital twin 20 as a set of data points 21 obtained from the simulation steps.

FIG. 2 depicts a representative portion of the parameter table data 5 to explain the “back and forth” described further above. The first column 10 represents the simulation step number, starting from 1 representing a first simulation run using the boundary conditions 1 comprising the corresponding parameter values 4 corresponding to the first row 11 within the parameter table data 5.

The third step of the computer-implemented method comprises solving the system of equations using each of the boundary conditions 1 to provide a corresponding simulation result, respectively, in a simulation step. In this case, for the first simulation step shown in the first column 10 and the first row 11, the first parameter value, the first value 12 from the second column 13, the second parameter value, the first value 14 from the third column 15 and the third parameter value, the first value 16 from the fourth column 17 are used. Here, the parameter values 12, 14 and 16 of the first row 11 represent the first boundary conditions 18.

According to the computer-implemented method, a single one of the parameter values 4 of a respective boundary condition 1 is changed from one simulation step to the next simulation step, while the other parameter values 4 belonging to the respective boundary condition 1 remain unchanged. As shown in FIG. 2, considering the first five simulation steps, as shown by the numbering 1 to 5 in the first column 10, it can be seen that the values of the first parameter value 12 are changed from 0.400 to 0.600, whereas the values of the second parameter value 14 are kept unchanged at 7.000 and the values of the third parameter value 16 are kept unchanged at 10.000. Due to this measure, the process simulation software 8 can calculate a new simulation result correspondingly fast, because it converges quickly. It can be further noticed that the step size of the first parameter value 12 is taken to be a small value of 0.5, as a smaller step size leads to a better and faster convergence of the simulation result. Furthermore, the simulation result from one simulation step is used as the initial conditions for the next simulation step. For example, the simulation result of the first simulation step using the first boundary conditions 18 will be used as the initial conditions for the second simulation step using the second boundary conditions 19.

After the first five simulation steps, as shown by the numbering 1 to 5 in the first column 10, for the sixth simulation step, the value of the second parameter value 14 from the third column 15 is changed from 7.000 to 7.500 keeping the other two parameters values. In the sixth simulation step, the first parameter value 12 in the second column 13 is kept at the same value of 0.600 as that from the fifth simulation step. Similarly, the third parameter value 16 from the fourth column 17 is kept constant at the same value of 10.000 as that from the fifth simulation step. Once, the second parameter value is changed to the value of 7.500 in the sixth simulation step, then the values of thirst parameter values are changed from 0.600 to 0.400, whereas the second parameter value 14 and the third parameter value 16 are kept at unchanged at the values of 7.500 and 10.000, for the simulation steps of 6 to 10. After that, the similar simulation process is then further repeated till all the parameter values 4 are considered to obtain the respective simulation results.

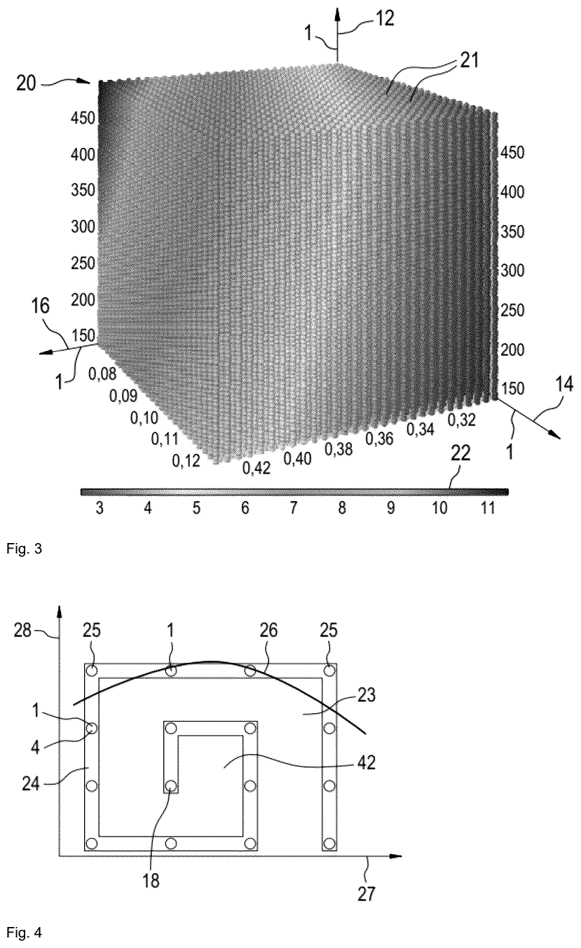

FIG. 3 shows that the digital twin 20 is the set of data points 21 comprising a plurality of simulation results in correspondence to the respective boundary conditions 1. Here, each of the three axis represent the first parameter value 12, the second parameter value 14 and the third parameter value 16, of the boundary conditions 1, respectively. The coloring of each data point 21 represents the corresponding simulation result. The value of the simulation result of each data point of the set of data points 21 can be obtained by means of the color scale 22.

For the sake of understandability, the digital twin 20 depicts the first parameter value 12 as being dependent on the other two parameter values 14 and 16. However, in a simulation the digital can comprise a plurality of parameter values, e.g., larger than 200 parameter values. The values and dependencies of each of the parameter values can be displayed in the form multi-dimensional graphs or plots or other representative forms which can be known to a person skilled in the art.

FIG. 4 shows a first path 24 of choosing the boundary conditions 1 from a simulation space 23, the x-axis representing rotational speed 27 and the y-axis representing torque 28. Here, the plurality of boundary conditions 1 are obtained from the simulation space 23, wherein the first boundary condition 18, that is the boundary condition 1 for a first simulation step is chosen from a central region 42 of the simulation space 23. Since generally the boundary regions 25 of the simulation space 23 comprise extreme values of a range of parameter values 4 of the boundary conditions 1 for which the simulation results need to be obtained. Simulations at such boundary regions 25 would require a long time to converge or do not converge or diverge, thereby leading to unrealistic values. This leads to a disproportionate loss of time that occurs when trying to find a solution numerically in physically or chemically boundary regions. Such boundary regions 23 are not selected and hence, the first path 24 is adjusted, as shown by the adjustment path 26. Thereby, the use of homotopy can be avoided or reduced.

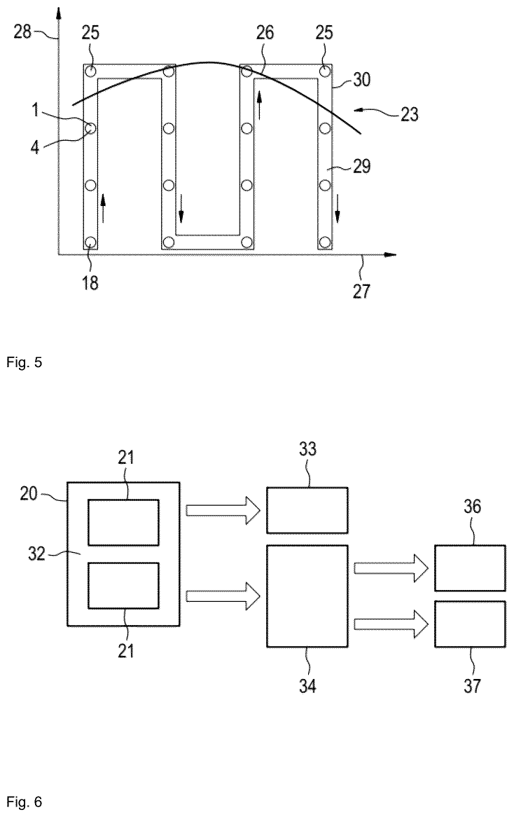

FIG. 5 shows a second path 29 of choosing the boundary conditions 1 from the simulation space 23, the x-axis representing rotational speed 27 and the y-axis representing torque 28. Here, the plurality of boundary conditions 1 are obtained from a simulation space 23, wherein the first boundary condition 18, that is the boundary condition 1 for a first simulation step is chosen from region of a very low rotational speed 27 from the simulation space 23. The second path 29 of choosing the boundary condition 1 for the next simulation step is adjusted dynamically through the simulation space 23 based on the time required for obtaining the simulation result in the previous simulation step. Here the second path 29 of selection of the boundary conditions 1 for the next simulation step is chosen based on whether the time required by the solver for a simulation result becomes longer than the previous simulation step, if the time required is longer, for example in the boundary regions 25, than the particular boundary condition 1 could be bypassed, as shown by the adjustment path 26 and the second path 29 of selection of the boundary conditions 1 within the simulation space 23 is adjusted accordingly, for example the second path 29 is in the form of a meander 30. Here, the boundary conditions 1, especially in the boundary regions 25, requiring large time for the simulation are avoided, thereby the use of homotopy can be avoided or reduced.

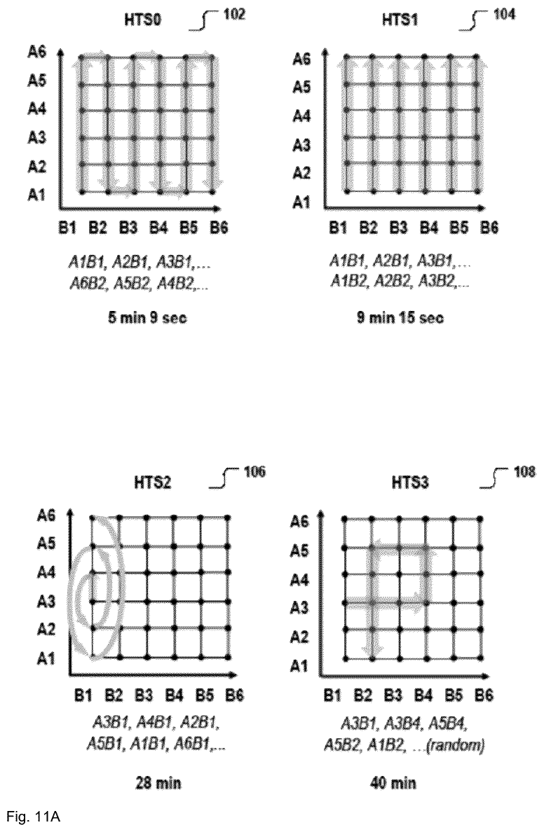

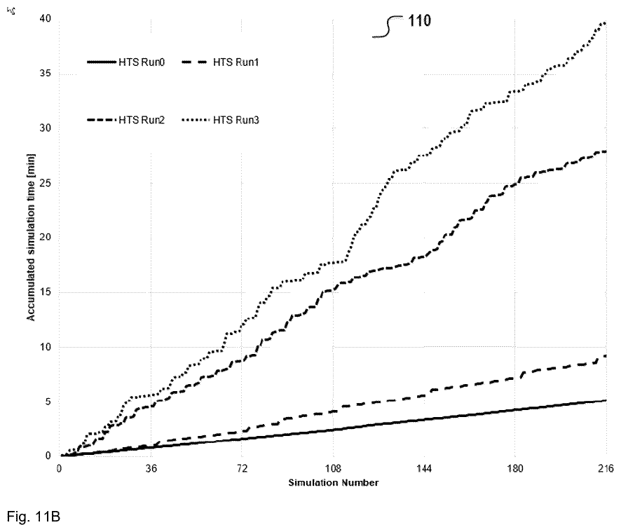

FIG. 6 shows a flow chart of an embodiment of the computer-implemented method, wherein the digital twin 20 is provided as a set of data points 21 obtained from the simulation steps. The set of data points 21 are be stored in the form of a data file 32, such as a comma-separated values data “CSV data”. The digital twin 20 is the set of data points 21 comprising a plurality of simulation results in correspondence to the respective boundary conditions 1, as shown in FIG. 1. This would enable a user to select or filter out a specific group of points from the digital twin 20 as per the requirements, so as to obtain the respective simulation results in correspondence to the respective boundary conditions 1 in a fast and efficient manner. The digital twin 20 can be represented by means of a visualization plot, for example a 3D-plot 33, also shown in FIG. 10, wherein a user can select or filter out a specific group of points from the digital twin 20 as per the requirements, for example by means of a digital slider 35, as shown in FIG. 10. The digital twin 20 is used to train an artificial intelligence model 34 or a machine learning based model (not shown in figures). The artificial intelligence model 34 or the machine learning based model can be of advantage for the visualization of big data of the simulation results together with corresponding boundary conditions 1, a fast optimization can be enabled and also a real time optimization and advanced process control can be enabled. Furthermore, the artificial intelligence model 34 can be used in grey box models 36 and surrogate models such as a neural network model 37.

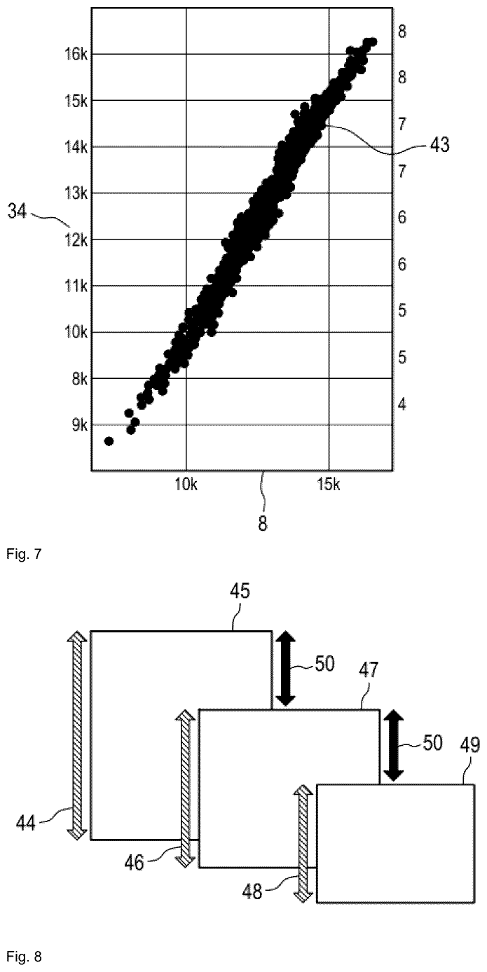

FIG. 7 shows a comparison of the simulation results obtained by the artificial neural network model 34 and the ACM solver 8 of 2-step biogas process. It can be seen that the prediction by the artificial neural network model 34 and the ACM solver 8 match very well, as all the resulting points lie around a straight line 43 inclined at an angle 45° with each of the axis.

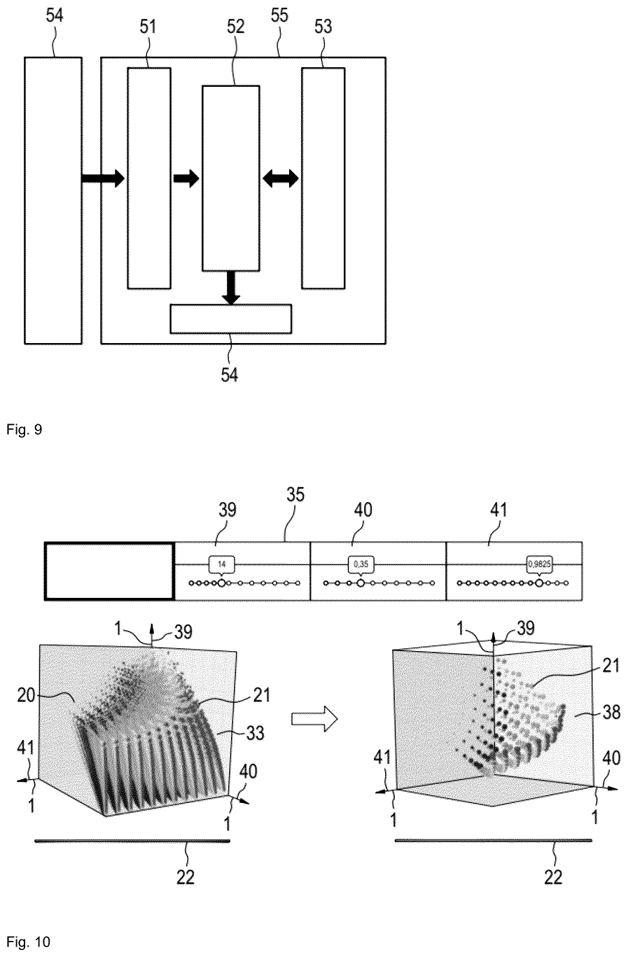

FIG. 8 shows a flow chart embodiment of the computer-implemented method, wherein in the case of parallel simulations, wherein a time offset 50 can be used for starting a solving of each of the system of equations in parallel with respect to solving one of the system of equations. Such parallel simulations can be run on a single computer 55, shown in FIG. 9, or cluster. For example, a simulation may usually takes 0.4-2 seconds. For parallelization there can be an offset of 45 seconds. To load, open and start a simulation file or step with ACM, a start value is read in, and the first point can be approached by homotopy, which may take about 1-2 minutes. But this depends strongly on the complexity of the mathematical model and on the duration of the homotopy. For example, about 6-8 parallel simulations can also be started simultaneously on the server computing system.

As shown in FIG. 8, three simulation files or steps are shown, only for the sake of understandability, it is shown that the first time of duration 44 of the first simulation file 45 is larger than the second time of duration 46 of the second simulation file 47, which is further larger than the third time of duration 48 of the third simulation file 49. Here, a time offset 50 is be used for starting a solving of each of the system of equations of one simulation file 45, 47, 49 in parallel with respect to solving one of the system of equations in the other simulation file 45, 47, 49. The time offset can be a predefined value, which may be varied for different simulation steps.

For example, if 30 000 simulation points need to be simulated and it is assumed that each simulation point requires 1 second on an average to be simulated. One would not wait for 30 000 seconds, i.e., about 8.4 hours approximately. Hence, in this case, the ACM simulations can be parallelized in three simulation files or steps, i.e., the first simulation file 44, the second simulation file 47 and the third simulation file 49. In each of simulation file 10 000 simulation points need to be calculated, which means about 3 hours. But if all the three simulation files are started at the same time, the computer/server may go down. Therefore, the first simulation file 45 can be opened first and the simulation with 10 000 points can be started. Loading, opening and starting may require a lot of computer resources. Therefore only one simulation file is opened, in this case the first simulation file 45. In addition, the 1st point of the first simulation file 45 is always started by homotopy, as there are no start values at the 1st run, which takes about 1-2 minutes. The 2nd simulation point takes only 0,5-2 seconds, because the old result from the simulation of the first point is available as start value for the 2nd point. Further, each of the following simulations of the following points may take about only 0,5-2 seconds, respectively.

With a time offset of 50, which may be 45 seconds, the second simulation file 47 is started. Then again after 45 seconds, the third simulation file 49 is started. The choice of the value of the time offset 50 would be dependent of how long it takes to start the simulation file and how long for this the computer is “busy”.

It is to be noted, that any of the time duration 44, 46, 48 can be larger or smaller than the any of the other time duration 44, 46, 48. Further, the division of the simulation points into three simulation files is just an example. The simulations can be parallelized into a chosen number of simulation files by a person skilled in the art. The choice of the number of simulation files may be dependent on the total number of simulation points that need to be simulated, the complexity of the simulation itself, the available computational resources, the number of points that do not converge and where a respective homotopy needs to considered, as well as the time needed for the completion of the simulations. It is of advantage to start the parallelized simulations with a time offset 50 because this would smoothen the total required processor power over time.

FIG. 9 shows a schematic diagram of a computer 55 for generating a digital twin for a chemical process or an apparatus or a system of a chemical plant, in particular for substance synthesis and/or substance separation configured to use the computer-implemented method. The computer 55 comprises an input unit 51, which is configured to receive boundary conditions 1, as shown in FIG. 1, form an external source 54. The transmission of the boundary conditions 1 between the external source 54 and the input unit 51 can be conducted in a wired or wireless manner. The computer 55 comprises a storage unit 52, which is configured to store the received boundary conditions 1. The computer 55 comprises a processor 53 comprising a computational model 2, as shown in FIG. 1, and is configured to solve the system of equations with the boundary conditions 1. The simulations results of obtained from the processor 53 can be stored in the storage unit 52 as a digital twin 20, shown in FIG. 1, as depicted by the double arrow. The computer 55 comprises an output unit 54, which is configured to output the simulation results from the digital twin 20 from the storage unit 52.

FIG. 10 shows a filtering of data obtained from the digital twin 20. The digital twin 20 is the set of data points 21 comprising a plurality of simulation results in correspondence to the respective boundary conditions 1. A specific set of data points out of the set of data points of the digital twin 20 can be selected select or filtered as per the requirements, so as to obtain the respective simulation results in in correspondence to the respective boundary conditions 1 in a fast and efficient manner. The digital twin 20 can be represented by means of a 3D-plot 33, wherein a user can a user to select or filter out a specific group of points from the digital twin 20 as per the requirements, for example by means of a digital slider 35, as shown in FIG. 8, to obtain a filtered 3D-plot 38. Here, ranges of three parameter values 4, namely pressure 39, CO2 concentration 40 and CH4 purity 41 are varied as per requirements, for example range of pressure with a maximum pressure 39 of 14 bar, maximum CO2 concentration 40 of 0.35 and maximum CH4 purity 41 of 0.9825. The coloring of each data point 21 represents the corresponding simulation result. The value of the simulation result of each of the data point of the set of data points 21 can be obtained by means of the color scale 22. The visualization and the filtering process can be incorporated as a web application. Hence, the computer-implemented method thereby enables the generation of a digital twin for a chemical process or an apparatus or a system of a chemical plant, in particularly in the field of gas mixtures that are separated by means of gas separation membranes due to different permeabilities of the individual gases.

FIG. 11 is an illustration of the impact of step selection (step width and path topology) on simulation performance. Often, each simulation uses the values of a plurality of boundary condition parameters as input, whereby the number of boundary condition parameters considered in some cases more than 3, or more than 5, or more than 7 or more than 9. The number of values evaluated per parameter may on average be e.g. at least 2, at least 4, at least 8, at least 64 or at least 256. Thousands or even hundred thousands or millions of simulations may be executed. Here, for the sake of simplicity, the simulations have been performed on a simplified grid of 3 different boundary condition parameters and 6 different values per parameter. Hence, for simulating all possible value combinations, 6×6×6=216 simulations have to be performed.

To simplify the illustration of the simulations even more, the grids depicted in FIG. 11A only show two of the three different boundary condition parameters: the x-axis of each of the grids 102-108 may represent the boundary condition parameter B, e.g. the A1/A3 membrane surface ratio of a three-stage gas separation plant, whereby six different parameter values B1, B2, B3, B4, B5 and B6 are depicted. The y-axis of each of the grids 102-108 may represent the boundary condition parameter A, e.g. the recirculation of the three-stage gas separation plant, whereby six different parameter values A1, A2, A3, A4, A5 and A6 are depicted.

For the sake of simplicity, a grid with 6 possible values for 3 different parameters was used as the basis for the simulations, whereby the increments between the different values of the same parameter were assumed to be equidistant, and the grids depicted in FIG. 11 have equidistant grid sizes in both dimensions. Typically, however, the parameters differ in terms of the number of possible different values as well as in terms of the step size and the unit, if any.

Grid 102 represents a single-step data selection (single step parameter value change) approach according to embodiments of the invention: in the first five simulation runs, only the first boundary condition parameter A is varied from A1 to A6 while parameter B is kept constant at value B1. Then, A is varied backwards from A6 to A1 while B (but not the other parameter C) has a value incremented by a single step from B1 to B2. The overall runtime required for executing all 216 parameter value combinations based on a parameter value change schema illustrated in plot 102 is 5 min 9 sec.

Grid 104 represents a different approach: in the first six simulation runs, A is varied from A1 to A6 while the parameter B (and the not depicted parameter C) is kept constant. Then, B is assigned a new value incremented by 1, but A is now again varied from A1 to A6 (not from A6 to A1 as shown in 102). Then, in the next six simulation runs, B is again assigned a new value incremented by 1, and A is again varied from A1 to A6. The time required for executing all 216 parameter value combinations based on a parameter value change schema illustrated in plot 104 was almost twice as long as for grid 102, namely, 9 minutes and 15 seconds.

Grid 106 shows a boundary condition parameter value selection which “jumps” from A3 to A4, then from A4 to A2, then from A2 to A5, and then from A5 to A1, and from A1 to A6. During these six steps, the values for B are kept constant (as illustrated by the depicted parameter B which always has the value B1). As can be inferred from grid 106, the change of the boundary condition A is not based on “single steps”, but rather on “jumps”, i.e., a parameter value change by more than one increment. For further simulation runs (not shown in 106, parameter B was varied on a single-step basis. Although only a single parameter was changed from one simulation to the next, the “jumps” performed when changing a single parameter over more than one increment resulted in a significantly prolonged runtime of 28 minutes for the 216 simulations.

Grid 108 shows a random boundary condition parameter value selection strategy. In the depicted example, both the “step width” and the number and identity of boundary conditions varied in each simulation vary randomly. In the depicted example, a runtime of 40 minutes was observed for executing the 216 simulations, which is almost ten times longer than the simulation strategy according to embodiments of the invention illustrated in grid 102.

Plot 110 of FIG. 11B shows the accumulated runtime for executing the 216 parameter value combinations for the four above-described parameter-selection strategies. As can be inferred from plot 110, the parameter value selection strategy according to embodiments of the invention (HTS Run0) quickly and significantly outperforms the three alternative approaches (HTS Run1-3) corresponding to grids 104-106.

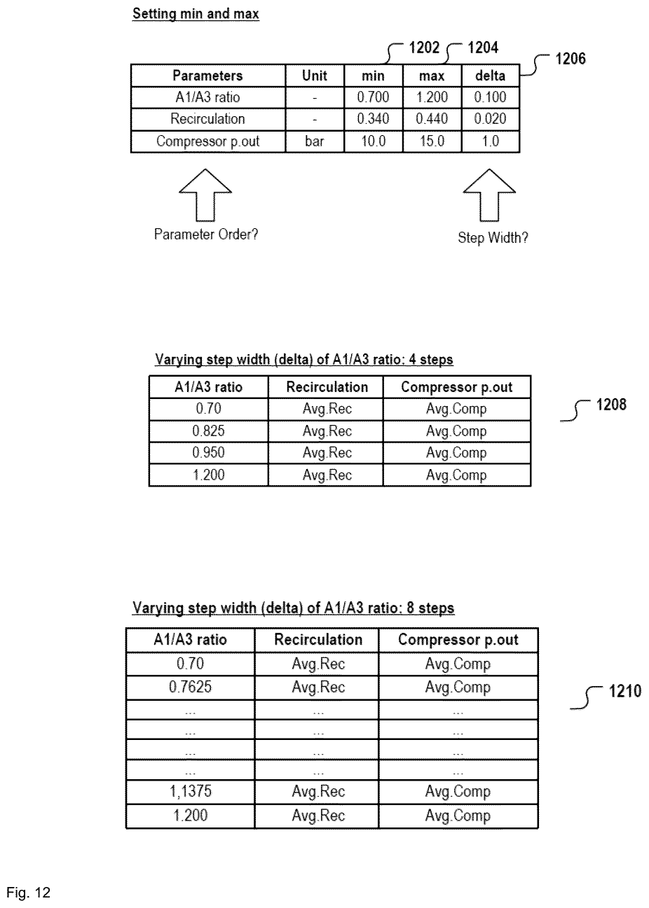

FIG. 12 is a set of tables for illustrating the identification of a suitable step width for increasing simulation speed and minimizing CPU resources required for performing the simulations. According to preferred embodiments, the multiple simulations are executed such that only one parameter value is changed from one simulation to the next, whereby the change is performed such that a parameter value immediately following the previously used parameter value in a predefined, parameter-specific series of parameter values is used. This approach may also be referred to as “single step” parameter value change approach (i.e., no jumps, to change of a parameter value from one simulation to the next by more than one increment). The parameter can be, for example, a parameter of a boundary condition or an initial condition.

For example, the series of data values specific for and assigned to a particular parameter can be a series of discrete and preferably equidistant different values spanning a range of values allowed for said parameter and assigned to said parameter. The range of values is defined by a minimum value and a maximum value. Depending on the parameter, the values may also have a unit such as °C or kg or m2. Different parameters can have different numbers of allowed parameter values assigned to them.

Applicant has observed that both the order of the parameters to be changed during multiple simulations and the “step width” (or “increment”), which corresponds to and determines the number of allowed parameter values assigned to each parameter, have an impact on the performance and accuracy of the simulations: if the step width is too small, the number of simulations will drastically increase, leading to a significantly reduced performance. If the step width is too large, the simulations may not converge or may not provide for a digital twin which accurately represents a sufficient number of relevant states of operation of the chemical process, apparatus or system.

According the depicted example, three boundary condition parameters exist, namely: A1/A3 ratio, recirculation and compressor outlet pressure.

The parameter A1/A3 ratio is indicative of the ratio of the membrane areas used in the first and third stages of a gas separation facility. For example, the gas separation facility can be a facility for separating a crude gas stream, which is conducted in an apparatus comprising a feed stream separation stage (first stage), a retentate separation stage (second stage) and a permeate separation stage (third stage). The facility may comprise one or more membranes in each in the three separation stages, and may comprise at least one compressor. An example of such a system is described in EP 2 588 217 B1. For example, the first stage can be a membrane separation stage for separation of the feed stream into a first permeate stream and a first retentate stream. The second separation stage can be a membrane separation stage, which may be of the same or different construction as the feed stream separation stage, for separation of the first retentate stream into a second permeate stream and a second retentate stream. The third separation stage may refer to a membrane separation stage which may be of the same or different construction as feed stream separation stage and/or the retentate separation stage, and may be used for separation of the first permeate stream into a third permeate stream and a third retentate stream. In the depicted example, the A1/A3 ratio shall be allowed to be a value between 0.700 and 1.200 and the minimum and maximum values are set accordingly.

The parameter recirculation is indicative of the fraction of the retentate of the second stage which is compressed and recirculated into the previous stage relative to the feed stream of the second separation stage. In the depicted example, the recirculation shall be allowed to be a value between 0.340 and 0.440 and the minimum and maximum values are set accordingly.

The parameter “compressor outlet pressure” indicates the pressure on the feed side of the feed stream separation stage (first separation stage). The pressure may be generated by a compressor arranged up-stream of the feed stream separation stage. In the depicted example, the pressure generated by the compressor shall be allowed to be a value between 10.0 and 15 bars and the minimum and maximum values are set accordingly.

Typically, the min and max values are set by a user taking into account e.g. literature values and/or parameter values known to be tolerable or supported by the gas separation facility whose operation is to be simulated. Ins some embodiments, the min and max ranges simply define the value ranges which shall be simulated as they are of interest for a particular gas separation facility design or use project.

Table 1206 does not only show the min and max values of the three example parameters, but also a step width “delta” found to have the advantage of providing the simulation results particularly fast. In order to determine a suitable step length (“delta” or “increment”) for each parameter, a “step-length-determination method” (SLD-method) is execute by the computer. In order to determine a suitable order of parameters whose values shall be varied first, a “parameter-order-determination method” (POD-method) is executed by a computer.

The SLD method comprises the following steps:
a) Assigning to the first parameter (e.g.: A1/A3 ratio) a first series of distinct, preferably equidistant parameter values lying within the min and max parameters assigned to this parameter. For example, as shown in table 1206, four different parameter values ranging from 0.70, 0.825 to 1.200 are assigned to the A1/A3 ratio. To the second and third parameters, a mean value of their respective parameter range is assigned (see table 1208: Avg.Rec and Avg.Comp).
b) For each set of parameter values obtained thereby, e.g., for each line of table 1208, performing a simulation of the design and/or dynamic behavior of the gas separation facility using said set as input, e.g. as parameter values of the boundary conditions and/or initial conditions.
c) Assigning to the first parameter (here: A1/A3 ratio) a second series of distinct, preferably equidistant parameter values lying within the min and max parameters assigned to this parameter, whereby the second series comprises more values than the first series. For example, as shown in table 1210, eight different parameter values ranging from 0.70, 0.7625 to 1.200 are assigned to the A1/A3 ratio. To the second and third parameters, a mean value of their respective parameter range is assigned.
d) For each set of parameter values obtained in step c), e.g., for each line of table 1210, performing a simulation of the design and/or dynamic behavior of the gas separation facility using said set as input, e.g. as parameter values of the boundary conditions and/or initial conditions.
e) Steps c and d) are repeated multiple times, where by in each repeat, the number of values in the series of distinct data values assigned to the first parameter is increased (e.g. may double). The repeating may continue until a predefined termination criterion is reached, e.g. a predefined maximum number of repeats, a maximum number of distinct data values in a series, etc.
f) Steps a)-e) are repeated for a different one of the boundary condition parameters. For example, the number of data values in the series of data values assigned to the parameter “recirculation” may be increased in each repeat, while constant average values are used for the other parameters “A1/A3 ratio” and “compressor”.
g) Step f) is repeated until each of the parameters of the boundary conditions has been used once as the parameter whose assigned series of “allowed” distinct data values is increased in each of the repeats defined in c) and d).

As mentioned above, each of the multiple series of distinct data values assigned to a given parameter (which correspond to step a) and c) and tables 1208, 1210) may be used for performing a set of simulations, whereby each distinct data value of this series corresponds to one simulation. The total time for performing all simulations in step b) (and d)) are measured and stored.

Applicant has observed that the total simulation time required per step b) or d) for all simulations will typically decrease with increasing number of data values in a series. However, after the data value series has exceeded a threshold of distinct data values comprised therein, the total simulation time will increase.

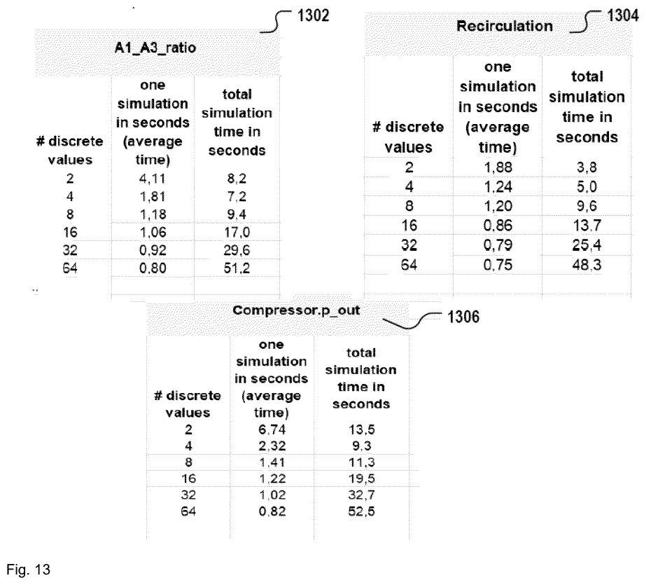

The suitable series of data values to be assigned to a given parameter will often be the one having the shortest total simulation time for performing all simulations defined by the parameter value combinations created in step b) for this data value series. The step width of a single step, i.e., the “delta” in table 1206, is defined by the distance of two subsequent data values in the data value series having been observed to provide the shortest total simulation time for all values in said series. Hence, according to embodiments of the invention, the SLD method comprises automatically identifying, for one or more of the boundary condition parameters, a suitable step length (and hence, a suitable number of different, predefined values to be used and changed during the simulations), the identification comprising identifying the series of distinct data values having the shortest total simulation time for performing all simulations defined by the parameter value combinations created in step b) for this data value series. An example of the selection of a suitable step length for a parameter is illustrated in FIG. 13 table 1302 comprising in the first column the number of discrete values per parameter evaluated and in the second column the simulation time of a single simulation. The total simulation time for the lines 1-4 are provided in the third column of the respective tables.

Hence, for the parameter A1/A3 ratio, the suitable step length/series of distinct data values should be chosen such that the predefined parameter value range comprises 4 different parameter values which are to be changed during the simulations, because 4 different parameter values correspond to the shortest total simulation time of 7.2 seconds.

A different parameter may be assigned a different step length/different number of discrete data values.

According to some embodiments, the automatically identified best suited list of distinct parameter values may be modified manually, e.g., in order to obtain a better resolution. For example, using 8 instead of 4 different values for the A1/A3 ratio would double the resolution of the simulation result, bund increase the simulation time only slightly.

Furthermore, for some parameters, no minimum curve may be observed when evaluating the total simulation times for an increasing number of different data values. For example, the total simulation time for the lines 1-4 of the table 1304 for parameter recirculation would be minimal when only two different parameter values used. In those cases, the number of different values assigned to a parameter and changed during the simulations may be set manually, as a tradeoff between simulation runtime and the need to evaluate different values to receive a sufficiently fine-granular set of data point which reflects the impact of this parameter on the overall gas separation process with sufficient detail. Small step sizes are usually (somewhat) slower than large step sizes (from 4), but may not provide sufficient details for each parameter.

Hence, the above-described automatically executed SLD method may optionally comprise a manual step for manually modifying the number of different data values/step width identified for each parameter by the SLD-method.

The SLD method is used for identifying a suitable, parameter-specific schema of value increments, whereby the increments can be of identical or different size. If the value increments of a parameter are identical, this means that the parameter value is incremented or decremented from one simulation to the next always by an increment of a constant, parameter-specific size (“step length”).

The simulations performed for determining the step-length of a parameter, which corresponds to the number of different values to be assigned to a parameter, use the same system of equations used later for performing the simulations yielding the digital twin. However, as the other boundary condition parameters always use a constant, average value, the simulations are much faster and are not used for generating the digital twin. Hence, the simulations performed in the SLD-method are also referred to as “preliminary simulations”.

FIG. 13 shows a set of tables for illustrating the identification of a suitable parameter order (POD-method). The POD-method is typically executed after the SLD-method has been performed, i.e., after having identified a parameter-specific “step length” (corresponding to a respective series of distinct parameter values within a value range defined by given min and max values). This may have the advantage of making use of already existing computation times as depicted in the tables of FIG. 12. However, it is also possible to execute the POD method after a user having selected suitable parameter-specific step-lengths completely manually. However, eve in this case, the preliminary simulations are executed as the results may be needed as basis for determining an order of parameters to be changed which is particularly fast.

The POD method is executed for identifying the one out of a plurality of boundary condition parameters to be the first one to be varied during the simulations. This is performed by selecting as the first boundary condition parameter to be varied in the course of the simulations the parameter which—at least for the determined, best-suited number of data values assigned to this parameter in the SLD method—yields the fastest result per simulation. In some embodiments, this is performed by selecting as the first boundary condition parameter to be varied in the course of the simulations the parameter which—for the majority of series of distinct data values assigned to this parameter in the SLD method—yields the fastest result per simulation. The simulation time may be determined using preliminary simulations wherein the values of the other parameters are not varied but rather are set to a constant value, e.g. the average of their respectively assigned value range.

For example, the parameter to be used the first parameter to be varied can be determined by analyzing the results of the SLD method, in which simulations are performed based on boundary parameter values chosen such that only one parameter is varied in value at a time and all other parameters have only the average of their value range assigned by min and max in each case. The three tables 1302, 1304, and 1306 illustrate the simulation times per preliminary simulation (second column) and for all simulations for a given number of different parameter values (third column) obtained for a particular parameter assuming a given number of different values, e.g., 2, 4, 8, 32, and 64.

Table 1302 shows the times required for performing various simulations performed when executing the SLD-method: the average measured time for computing an individual simulation when the A1/A3 ratio is assigned a series with only two distinct values (while the recirculation and the compressor parameter have assigned a constant mean value) is 4.11 seconds. The average measured time for computing an individual simulation when the A1/A3 ratio is assigned a series with 4 distinct values (while the recirculation and the compressor parameter have assigned a constant mean value) is 1.81 seconds. The average measured time for computing an individual simulation when the A1/A3 ratio is assigned a series with 8 distinct values is 1.18 seconds.

Table 1304 shows the times required for performing various further simulations performed when executing the SLD-method: the average measured time for computing an individual simulation when the recirculation is assigned a series with only two distinct values (while the A1/A3 ratio and the compressor parameter have assigned a constant mean value) is 1.88 seconds. The average measured time for computing an individual simulation when the recirculation is assigned a series with 4 distinct values (while the A1/A3 ratio and the compressor parameter have assigned a constant mean value) is 1.24 seconds. The average measured time for computing an individual simulation when the recirculation is assigned a series with 8 distinct values is 1.20 seconds.

Table 1306 shows the times required for performing various further simulations performed when executing the SLD-method: the average measured time for computing an individual simulation when the pressure generated by the compressor (“compression”) is assigned a series with only two distinct values (while the A1/A3 ratio and the recirculation parameter have assigned a constant mean value) is 6.74 seconds. The average measured time for computing an individual simulation when the compression is assigned a series with 4 distinct values is 2.32 seconds. The average measured time for computing an individual simulation when the compression is assigned a series with 8 distinct values is 1.41 seconds.

As can be inferred from the measured times in the three tables, the smaller the step size/the higher the number of distinct parameter values assigned to a parameter, the faster an individual simulation will be. However, the performance gain per individual simulation slows down and reaches a plateau.

A comparison of the simulation times obtained for the different parameters and for different number of allowed, discrete parameter values depicted in tables 1302-1306 reveals that für basically every number of discrete values (e.g., for 2, 4, 6, 8, 16, 32 or 64 discrete values), a single-step variation of the recirculation ratio has a faster performance than a single-step variation of the A1/A3 and in particular than a single-step variation of the compression parameter.

For example, assuming each of the three parameters having assigned a series of 16 discrete vales respectively representing the most suitable number of distinct data values, the time per individual simulation step is 1.06 seconds for the A1/A3 ratio, which is slower than the 0.86 seconds of the recirculation, but faster than the 1.22 seconds required for a step-wise variation of the compression parameter assuming 16 distinct values. Hence, under the assumption each of the three parameters would have 8 distinct values, the order of the parameters being changed during the simulations would be, from left to right: recirculation, A1/A3 ratio, compression.

However, typically different parameters will have different numbers of data values to be changed. For example, As was explained above, the best suited number of distinct parameter values for the parameter A1/A3 ratio is 4, as it yields the shortest total time for executing the preliminary simulations: 4×1.81 sec=7.2 sec. The recirculation, however, may have assigned 16 different parameter values to provide sufficient details during the simulations for this parameter. The compressor may have assigned 4 different values, because 4×2.32 sec=9.28 sec provides the shortest time for executing all preliminary simulations depicted in table 1306. Hence, the situation of the example depicted in FIG. 13 is:

| | Best suited | | Order of varying |
|---|---|---|---|
| | number of | | the value of a |
| | different | | parameter when |
| | parameter | Time needed | performing the |
| | values | for individual | simulations to |
| | according | preliminary | provide the set |
| | to SLD | simulation | of data points/ |
| Parameter | method | step | digital twin |
| A1/A3 ratio | 4 | 1.81 | 2 |
| recirculation | 16 | 0.86 | 1 |
| compression | 4 | 2.32 | 3 |

As is shown in the table above, the SLD method is used for identifying a suitable number of different values per parameter. Then, the order of the parameter being varied is determined such that the shorter the execution time of a single preliminary simulation for the SLD-method-determined number of values, the earlier the values of the respective parameter are changed. Hence, in the depicted example, the recirculation would be varied first, then the A1/A3 ratio, then the compression.

It is often the case that the number of distinct, “allowed” data values per parameter may not be identical. For example, in the final simulation, the recirculation may have assigned 16 different parameter values which may have to be used as boundary parameter values, the A1/A3 ratio may have assigned 4 (or e.g. 8) parameter values and the compression may have assigned 4 distinct parameter values.

The consequence of selecting the recirculation as the first, the A1/A2 ratio as the second and the compression as the third parameter to be varied stepwise on the order of single-step parameter variations during the later simulation runs can be illustrated as follows, assuming each parameter has only two allowed values, referred herein as V1 and V2:

| Simulation | Recirculation | A1/A2 ratio | Compression |
|---|---|---|---|
| run | R | (AR) | (C) |
| 1 | R = RV1 | AR = ARV1 | C = C1 |
| 2 | R = RV2 | AR = ARV1 | C = C1 |
| 3 | R = RV2 | AR = ARV2 | C = C1 |
| 4 | R = RV1 | AR = ARV2 | C = C1 |
| 5 | R = RV1 | AR = ARV2 | C = C2 |
| 6 | R = RV2 | AR = ARV2 | C = C2 |
| 7 | R = RV2 | AR = ARV1 | C = C2 |
| 8 | R = RV1 | AR = ARV1 | C = C2 |

The order of the parameters therefore may ensure that the “fastest” parameter, recirculation, is changed most often during the simulation runs, while the “slowest” parameter, compression, is changed least often.

In more general terms, the simulation steps for computing the digital twin may be performed such that the first three boundary condition parameters whose values is to be changed is increased or decreased from one step to another according to the following schema, wherein “BCP” is a “boundary condition parameter, and V1, V2 are respective values assuming an assigned series of two different values per parameter:

| #simulation | BCP1 | BCP2 | BCP3 |
|---|---|---|---|
| 1 | BCP1 = BCP1V1 | BCP2 = BCP2V1 | BCP3 = BCP3V1 |
| 2 | BCP1 = BCP1V2 | BCP2 = BCP2V1 | BCP3 = BCP3V1 |
| 3 | BCP1 = BCP1V2 | BCP2 = BCP2V2 | BCP3 = BCP3V1 |
| 4 | R BCP1 = BCP1V1 | BCP2 = BCP2V2 | BCP3 = BCP3V1 |
| 5 | BCP1 = BCP1V1 | BCP2 = BCP2V2 | BCP3 = BCP3V2 |
| 6 | BCP1 = BCP1V2 | BCP2 = BCP2V2 | BCP3 = BCP3V2 |
| 7 | BCP1 = BCP1V2 | BCP2 = BCP2V1 | BCP3 = BCP3V2 |
| 8 | BCP1 = BCP1V1 | BCP2 = BCP2V1 | BCP3 = BCP3V2 |

For the sake of simplicity, the value changes during the 8 consecutive simulation runs shown in the table above are based on only three parameters respectively having assigned a series of only two distinct values. In reality, the number of parameters and the number of parameter specific data values may be much larger.

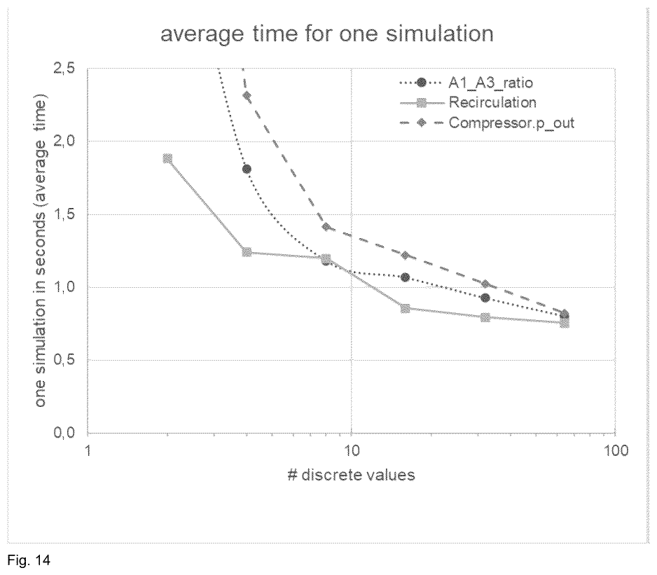

FIG. 14 shows a plot 1400 illustrating the observed mean simulation time for an individual simulation run when performing the SLD-method assuming 2, 4, 8, 16, 32 and 64 allowed different values per parameter. The x-axis has logarithmic scale. As can be inferred also from this plot, the recirculation parameter-except for the number of 8 parameter values per parameter-performs fastest, while stepwise varying the compression parameter takes the longest time.

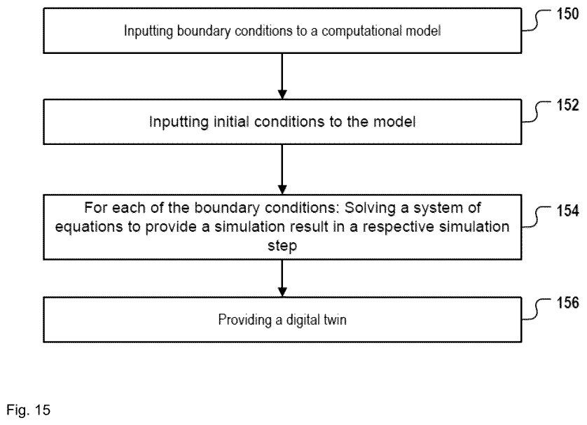

FIG. 15 shows a flow chart of a computer-implemented method for computing a digital twin of a chemical process or a digital twin of an apparatus or a system of a chemical plant. The method steps have already been described with reference to FIG. 1.

Examples of the invention may have the advantage that CPU and memory consumption required for performing a large number of simulations is minimized. For example, by changing only a single parameter value from one simulation to the next, while keeping the other boundary condition parameters constant, the number of parameter values which have to be read from a storage device into the main memory is reduced. Preferably, the single parameter value is changed such that the value is only increased or decreased by a single increment from one simulation to the next, so no jumps are executed.

Preferably, the specific way the single boundary parameter value is changed (with regards to the order of the parameter to be the first to change its value and/or with regards to the increment of changing this parameter) is chosen such that processing time is reduced. The selection of the order of parameters and the size of the increment (“step length”) may be based on empirical measurements of the times required for performing preliminary simulations, thereby taking into account the particularities of the computer system used for performing the simulations (preferably, the preliminary simulations and the final simulations may be performed on the same or on similar computer systems). Furthermore, as only a single boundary parameter value is changed at a time in a highly specific manner, the system of equations can be solved faster as the equations converge faster.

Thanks to the remarkable performance gains, a digital twin comprising a huge amount of data points can be created, thereby providing a digital representation of a chemical process or facility which is very detailed and hence highly accurate. A plurality of technical appliances for digital twins consisting of many hundred thousand or even millions of data points, respectively having assigned a plurality of boundary condition parameter values exist.

For example, the set of data points generated and provided as the digital twin can be used completely or at least partially for simulating, controlling or designing the chemical process or the apparatus or system of the chemical plant. For example, the simulation can be performed for creating or optimizing the design of a plant or chemical facility, e.g. a facility for separating gases or other types of material, at the design phase of the facility. The data points may be used directly, e.g. by executing an algorithm (e.g. a rules engine or another type of predefined algorithm) which uses the set of data points or sub-sets thereof as input. Alternatively, at least some of the data points obtained from the simulation steps are used as training dataset for training a predictive model using a machine-learning approach. In a consecutive step, the trained predictive model for simulating, controlling or designing the chemical process or the apparatus or system of the chemical plant.

| | |
|---|---|
| 1 | Boundary condition |
| 2 | Computational model |
| 3 | Initial condition |
| 4 | Parameter value |
| 5 | Parameter table data |
| 6 | Tabulated database |
| 7 | Column |
| 8 | Process simulation software |
| 9 | Graphic user interface |
| 10 | First column |
| 11 | First row |
| 12 | First parameter value |
| 13 | Second column |
| 14 | Second parameter value |
| 15 | Third column |
| 16 | Third parameter value |
| 17 | Fourth column |
| 18 | First boundary condition |
| 19 | Second boundary condition |
| 20 | Digital twin |
| 21 | Set of data points |
| 22 | Color scale |
| 23 | Simulation space |
| 24 | First path |
| 25 | Boundary regions |
| 26 | Adjustment path |
| 27 | Rotational speed |
| 28 | Torque |
| 29 | Second path |
| 30 | Meander |
| 32 | Data file |
| 33 | 3D-plot |
| 34 | Artificial intelligence model |
| 35 | Digital slider |
| 36 | Grey box model |
| 37 | Neural network model |
| 38 | Filtered 3D-plot |
| 39 | Pressure |
| 40 | CO2 concentration |
| 41 | CH4 purity |
| 42 | Central region |
| 43 | Straight line |
| 44 | First time of duration |
| 45 | First simulation file |
| 46 | Second time of duration |
| 47 | Second simulation file |
| 48 | Third time of duration |
| 49 | Third simulation file |
| 50 | Time offset |
| 51 | Input unit |
| 52 | Storage unit |
| 53 | Processor |
| 54 | External source |
| 55 | Computer |
| 102-108 | parameter value grid |
| 110 | plot |
| 1202 | minimum values |
| 1204 | maximum values |
| 1206 | parameter table |
| 1208-1210 | tables with parameter value combinations |
| 1302-1306 | tables with observed simulation times |
| 1400 | plot |

1-27. (canceled)

28. A computer-implemented method for generating a digital twin (20) for a chemical process or an apparatus or a system of a chemical plant, the method comprising the steps of:
a) inputting a plurality of boundary conditions (1) to a computational model (2), the computational model (2) comprising a system of equations, wherein each boundary condition (1) comprises a plurality of parameter values (4);
b) inputting initial conditions for solving the system of equations;
c) in a simulation step, solving the system of equations using each of the boundary conditions (1) to provide a corresponding simulation result;
wherein a single one of the parameter values (4) of a respective boundary condition (1) is changed from one simulation step to the next simulation step, while the other parameter values (4) belonging to the respective boundary condition remain unchanged; and
d) providing the digital twin (20) as a set of data points (21) obtained from the simulation steps.

29. The computer-implemented method of claim 28, wherein the method is for substance synthesis and/or substance separation.

30. The computer-implemented method of claim 28, wherein the single one of the parameter values (4) of the respective boundary condition (1) is varied in a simulation within its whole value set of data points from a starting data point to an end data point, wherein, in the subsequent series of simulation, the single one of the parameter values (4) of the respective boundary condition is varied backwards, from the end data point to the starting data point.

31. The computer-implemented method of claim 28, wherein the simulation result from one simulation step is used as the initial condition (3) for the next simulation step.

32. The computer-implemented method of claim 28, further comprising displaying the digital twin.

33. The computer-implemented method of claim 31, wherein displaying the digital twin comprises using an augmented reality display system.

34. The computer-implemented method of claim 32, wherein displaying the digital twin comprises generating 2D or 3D computer graphics visualizing the data in the digital twin; loading the 2D or 3D graphics into a frame buffer of a display system; and displaying the content of the frame buffer on the display system.

35. The computer-implemented method of claim 28, wherein the system of equations is a steady-state system of equations of a quasi-steady state process.

36. The computer-implemented method of claim 28, wherein the digital twin (20) is a database comprising a matrix of a plurality of simulation results in correspondence to the respective boundary conditions.

37. The computer-implemented method of claim 28, wherein the chemical process corresponds to that of a gas separation membrane or a gas separation arrangement with a plurality of gas separation membranes.

38. The computer-implemented method of claim 28, wherein a plurality of systems of equations, each using corresponding boundary conditions (1) to provide a corresponding simulation result, are solved in parallel in a simulation step.

39. The computer-implemented method of claim 38, wherein a time offset (50) is used for starting a solving of each of the system of equations in parallel with respect to solving one of the system of equations, wherein the time offset (50) is a predefined fraction of the average time of a simulation step.

40. The computer-implemented method of claim 39 wherein the predefined fraction lies between 5% to 10% of the average time of a simulation step.

41. The computer-implemented method of claim 28, wherein the digital twin (20) is used to train an artificial intelligence model (34) or a machine learning based model.

42. The computer-implemented method of claim 41, wherein the digital twin (20) is the set of data points (21) comprising a plurality of simulation results in correspondence to the respective boundary conditions.

43. The computer-implemented method of claim 28, wherein the simulation steps are performed such that no parameter value is increased or decreased from one step to another by more than one predefined, parameter-dependent increment.

44. The computer-implemented method of claim 28, wherein:
changing the single one of the parameter values of a respective boundary condition from one simulation step to the next simulation step is performed according to an order of boundary condition parameters;
the simulations are performed such that all values of a series of parameter values assigned to the first parameter in said order have to be traversed from the minimum to the maximum value and backwards before any value a subsequent parameter according to this order is changed;
wherein the method comprises: identifying the order of boundary condition parameters to be changed such that the simulation time is minimized.

45. The computer-implemented method of claim 28, wherein:
the number of simulation steps executed and the number of data points comprising the results of a respective one of the simulation steps is at least 100,000, and/or
the number of boundary condition parameters whose values are varied in the simulation steps is at least 3; and/or
the average number of predefined values assigned to one of the boundary condition parameters which are changed during the simulation steps is at least 2.

46. A computer program comprising instructions which, when the program is executed a computer (55), causes the computer to carry out the steps of the computer-implemented method of of claim 28.

47. A data structure configured for use for visualizing a digital twin (20) of a chemical process or an apparatus or a system of a chemical plant, the data structure comprising a plurality of data points obtained by a method according to claim 28, the data structure being configured to cause, upon being processed by a display system, the display system to generate a 2D or 3D computer graphics visualizing the data in the digital twin; and displaying the 2D or 3D computer graphics on an electronic display of the display system.
